(19) United States
(12) Patent Application Publication
(10) Pub. No.: US 2006/0232557 A1
(43) Pub. Date: Oct. 19, 2006

(54) Combination consisting of a computer keyboard and mouse control device

(76) Inventor: Wolfgang Fallot-Burghardt, (US)

Correspondence Address: Wolfgang Fallot-Burghardt, Johann-Schuette, Street 53, Mannheim, D-68307, DE

(21) Appl. No.: 10/497,988

(22) PCT Filed: Dec. 10, 2002
(86) PCT No.: PCT/EP02/13999

§ 371 Date: Jun. 8, 2004

(30) Foreign Application Priority Data
Dec. 11, 2001 (DE) 101 60 708.3

(51) Int. Cl. G09G 5/00

(52) U.S. Cl. 345/168

(57) ABSTRACT

The invention relates to a keyboard, particularly a computer keyboard, comprising a keyboard housing (1, 3) and a capacitive device, which comprises at least one electrode (35) and is provided for inputting position data for a mouse pointer. The inventive keyboard is characterized in that the at least one electrode (35) is situated inside the keyboard housing (1, 3). The invention makes it possible to combine the different functionalities of a keyboard and touch pad on the same'surface. The touchpad functionality constitutes a modular addition to common membrane keyboard technology.

### 1. TECHNICAL BACKGROUND

This invention relates to a keyboard, in particular computer keyboard. Furthermore, it relates to an electrode arrangement, in particular to be inserted into the keyboard housing of a keyboard, and an apparatus for controlling a cursor or mouse pointer by influencing the capacities using a hand.

### 2. DESCRIPTION

2.1 Introduction and Earlier Developments:

A mechanical/optical process is used for generating coordinate information for the ‘mouse’, today's most commonly used method for input of coordinates into a computer. In the conventional mouse architecture [1], the rotation of a ball, which has contact to a stationary pad, is transmitted on two wheels mounted in an x and y direction. Rotation of the latter is measured by counting how often the notches in the wheel pass the light barrier per unit of time. Thus, speed and direction of mouse movement can be measured. This aforementioned method will enable a high resolution of the position measurement. However, the disadvantages are that another piece of equipment is required as well as the keyboard, the hand has to leave the keyboard to move the mouse and thus the flow of writing is interrupted, and the optical measuring process is susceptible to becoming soiled (light barrier!).

The ‘touchpad’ generally used for portable computers is a panel which is usually recessed next to the keyboard on the side facing the user. After touching the surface with the fingertip, one can guide the mouse pointer by lateral movements of the finger. There are different methods of converting the position of the finger to electrical signals: in today's most common capacitive methods [2, 3,4] planar electrodes are embedded into a square grid on the bottom side of the touchpad. The electrical capacitance of the electrodes to the surrounding area as well as the capacity between the electrodes is measured periodically. When the finger approaches these electrodes the capacitances measured by them will change and suitable calculations will convert them to a pointer position.

The advantage of this method is the simplicity of the concept (omission of mechanical parts), the disadvantage is the limited size of the sensitive field which necessitates careful movements and that the hand—in this case too—has to move away from the keyboard.

Both the mouse and the touchpad share the disadvantage that the hand has to move away from the keyboard to move the mouse. The ‘pointing stick’ [5] is another common method for portable computers which avoids this disadvantage. The pointing stick is a vertical, elastic cylindrical stick which typically is mounted in the middle between the keys and which is slightly above the level of the caps of the keys. By bending the stick, the mouse pointer can be moved in the direction desired, whereby the extent the stick is bent (or the pressure applied) determines the speed of the mouse pointer. The bend can be measured by capacitive proximity sensors on the base of the stick.

The pointing stick does not need any other space outside the keyboard, which is why it is often used for small portable computers. The major disadvantage is the lack of user-friendly operation, i.e. many users complain that they cannot select their target exactly when using the pointing stick.

A new group of patents is based on the idea of using the surface of the keyboard itself as a touchpad in order to prevent the disadvantages mentioned above. This type of configuration has the advantages of intuitive and ergonomic operation, without requiring a separate device such as the mouse or additional space next to the keyboard (as in the case of the touchpad). Using the entire keyboard allows for a larger, sensitive area than the touchpad to be used, thus reducing the tedious multiple navigation over the touchpad in order to guide the mouse pointer to a location on the monitor which is far away. Most important is that the hand does not have to be removed from the keyboard to operate the mouse pointer. The methods described in the following do not require any mobile mechanics (susceptible for wear and tear) and, apart from the first method described below, optical measurements (susceptible for dirt and soiling).

C. Sellers ([6]) describes a camera-supported system by which the hand movements over/on the keyboard are recorded by a camera which, for example, can be mounted above the monitor, thus providing control information for the mouse pointer.

D. Santilli ([7]) describes an apparatus for moving a mouse pointer in which the surface of some of the keys of a keyboard is sensitive to touch. Together with suitably shaped fillings between the touch-sensitive keys, a kind of touchpad ensues in the middle of the keyboard. D. Santilli does not give details of any technical process for measuring the touch.

H. Philipp ([8]) describes in detail the technical implementation of D. Santilli's idea. This involves placing a conductive cover comprised of many individual electrodes on the circuit board below the keys, which is used for a support for the keys. In a ratiometric process, suitable electrode geometries (several are mentioned) will allow the position of the hand to be determined by measuring the electrode capacitives. The capacitances are measured by converting a charge proportional to the capacitance into voltage with the aid of a test capacitor. Since this patent is the closest to the invention described in this document, intensive discussions have to be carried out in order to disclose the differences. One initial disadvantage of the preferred embodiment of this patent is the combined capacitive/resistive method of determining the coordinates which requires a defined and homogenous level of resistance, which in turn suggests high demands on the production process. With a resistive method there is no inherent and fixed connection between the signals measured and the location of the activated object as in the case of a multi-electrode structure, where the location of the finger is restricted by the most strongly activated electrode. Local deviations in resistance caused by fluctuations in temperature or moisture thus lead to a drifting of the position measurement [4]. For these reasons and because integrated electronics are capable of economically processing the larger number channels, multi-electronic designs for touchpads have replaced those models which were based on resistive charging or current division. The electronics disclosed of the preferred embodiment are based on a charge division dependent on an RC-time constant, i.e. the measurement requires a precisely set period of measurement because the voltage on the measuring capacitor will change at the time of measure. Any faults which may occur while charging the RC will falsify the test results and cannot be subtracted.

The solely capacitive electrode information presented in the other realisations is not, on the other hand, capable of resolving finer objects such as individual fingertips. Another great disadvantage of this method is the manner in which the sensors are mounted. This involves placing a conductive cover along the edges underneath the keys on the exterior of the housing. This means cutting out more or less big areas in the cover for all keys because of the tappets. Furthermore, this configuration has the disadvantage that the sensors are subject to external influences (moisture!). Later, the conductive material will be defined as a conductive polymer or graphite printed paper; the latter being of course particularly unsuitable in the event of moisture.

H. R. Sterling ([9]) describes an apparatus by which an electrical signal (sine voltage) is injected into the left hand which in turn transmits to the right hand above the keyboard. The electrical signal in the right hand is detected by electrodes located on all sides of the keyboard. In a ratiometric process, the mouse coordinates in the x and y direction are extracted from the ratio of the signal strengths detected from opposite electrodes.

A major disadvantage of this method is that the signal injected into the hand will collapse once the body touches a grounded object (please also refer to the discussions on the electronic apparatus 2). One can therefore not work barefoot in the garden with a such-equipped portable computer. Moreover, the electrodes are mounted awkwardly resulting in the signal being probably very weak due to the large distance to the hand. Further, the same basic criticism of the related radiometric method stated above applies in this case, too. The signal amplification is based on the principle of synchronous detection; without mentioning all the details, a certain number of sine cycles have to be detected in order to reach stable test results. Any interference which occur in this potentially long period of time will falsify the results.

S. Mato ([10]) describes a combination of a keyboard and touchpad in which there is an electrode under each key. In the keyboard mode, a pressed key or an approaching finger is detected by the enlarged capacitance of the respective electrode, whereby the impact dynamics can also be recognised in a similar way to a piano. In the mouse mode the capacitances of the electrodes are measured periodically and thus the position of the hand or any movements can be detected which control the mouse pointer. A transimpedance amplifier is used to measure the capacitances.

One disadvantage of this patent is that the layout of the sensor arrangement is defined by the arrangement of the keys. Since these are not within a square grid, it prevents the sensors from being collected in a row and column as is practised in this patent. That means that each key sensor has to be connected to an amplifier by means of multiplexers, which not only involves a lot of effort, but also a large readout time. The arrangement of the keys also complicates a suitable sensor shape with pointed corners, which is advantageous for a ‘soft’ transition of the signal between neighbouring sensors. It is also unclear as to how homogeneously keystrokes can be detected because these also depend on the size, shape, position and grounding of the finger; the capacitive keyboards widely in use in the seventies had a conductive die mounted to the body of the key itself. The detection of the key threshold is more random and probably not as casual and immovable as with today's membrane keyboards, where the mechanical keystroke at the base of the housing triggers the contact. Therefore a soft touch of the key without exercising any pressure by a grounded finger could probably offset a letter. Another disadvantage is that this solution does not build ‘organically’ up on the widespread keyboard design. This means that keyboard manufacturers would have to discard the popular membrane design and the pertinent controller chip completely.

The principle of synchronous detection with all the disadvantages mentioned above is again used for signal amplification.

2.2 Object of the Invention

As was made quite clear in the previous chapter there are already a number of patents concerning the integration of computer keyboard and mouse control. It was also pointed out that all the methods mentioned have a few or more disadvantages. The object of this invention is to show an alternative and improved way of integrating the various functionalities of the keyboard and touchpad into the same area, whereby the touchpad components of this invention form a modular supplement to the widespread membrane keyboards. The design of these components follows to a large extent the design of popular capacitive touchpads as reliable and well-proven technology.

This object is solved by means of the keyboard according to claim 1, by means of an electrode arrangement according to claim 13, and by an apparatus according to claim 20 or 26. The dependent claims obtain advantageous embodiments of the invention.

According to the invention this object is reached by means of a keyboard, in particular a computer keyboard, including a keyboard housing and a capacitive apparatus comprising at least one electrode for entering the positional data for a mouse pointer, whereby at least one electrode is shaped in such a manner that the positional data can be entered by hand movement over the keyboard. This inventive keyboard is characterised in that the at least one electrode is located in the inner keyboard housing; hence the electrodes are protected within the keyboard housing.

With the keyboard comprising a number of keys and the electrodes being arranged such that a part of the electrodes can be located even beneath the keys, the electrodes layout can be designed as desired; no consideration has to be given to the key arrangement or the position of the holes in the keyboard housing. Hence in one embodiment of this invention, a least one electrode is arranged in such a manner that it is located at least partially beneath at least one key. With each key comprising one tappet, at least one electrode can be arranged such that it is located at least partially beneath the tappet of at least one key.

In a particular embodiment the at least one electrode is located on an electrode membrane. Electrode membranes are a casual, modular supplement to the membrane keyboards used so far. The well-proven principle of the membrane switch can continue to be used.

The at least one electrode can, for example, be printed on the electrode membrane. In particular a polyester membrane can be used as an electrode membrane. Employing a membrane has the advantage that membranes printed with graphite or silver ink are cheap and are state-of-the-art.

Another embodiment of the inventive keyboard is characterised in that it comprises membrane switches and the electrode membrane is located above the membrane switches. Moreover, a shield can be located between the electrode membrane and the membrane switches to prevent and minimise the interference of any coupling between the electrodes and the membrane switches. The shield can be realised by a shield membrane in particular. Alternatively, it can be applied, e.g. printed or vapour-deposited to the side of the electrode membrane opposite to the at least one electrode so that no additional membrane is required. In another alternative embodiment in which likewise no additional membrane is required for the shield, the keyboard comprises membrane switches including an upper keyboard membrane, whereby the shield is located on the upper side of the keyboard membrane.

In another embodiment of the inventive keyboard, the at least one electrode is applied to the upper keyboard membrane. Thus, inserting an additional membrane to the membranes of the membrane switches is not necessary. The shield effect can be realised—instead by a shield membrane—by suitable control of the voltage feed to the membrane switches or the electrodes. Such a kind of control device offers the possibility of omitting the shield in the other embodiments described, too.

The object of the invention is also achieved by an electrodes arrangement, in particular for insertion in the keyboard housing of a keyboard, which is characterised in that it has at least two electrodes, each of them being confined by a polygon line having at least two corners with angles of less than 45 degrees. Microscopically, there is almost always a rounding of the angle. Likewise, a pointed corner can be produced by a number of flat angles arranged within a small space. From the point of view of the invention, both versions are to be regarded approximately as a pointed angle.

A possible embodiment of the electrode arrangement is at least one electrode which is constructed from a concatenation of triangles, and/or at least one electrode extending into an orthogonal direction is constructed from a concatenation of rhombuses.

The inventive electrode arrangement offers the advantage that the position of small objects like fingertips can be determined precisely, using relatively few electrodes. It is advantageous when at least two of the at least two electrodes substantially extend in correlating vertical directions. The inventive electrodes arrangement offers the further advantage that the capacitance changes over softly from one electrode to the next one when the finger passes over them.

The electrodes in the electrode arrangement can be applied to—in particular printed on—an electrode membrane. The electrode membrane can at the same time be a keyboard membrane of the membrane switches. If the electrode membrane is at the same time an upper keyboard membrane the electrodes can be located on the upper side of the upper keyboard membrane. By using the keyboard membrane as an electrode membrane, or using the electrode membrane as a keyboard membrane, no additional membrane has to be inserted in the keyboard housing in order to equip a keyboard with an inventive electrode arrangement.

Further, the object of the invention is achieved by an apparatus for controlling the cursor or mouse pointer by modulating the capacitances with a hand. This apparatus comprises: a number of electrodes which are arranged in such a manner that they can form capacitances which are modulated by a hand; at least one AC feed for feeding AC voltage; at least one capture unit for capturing at least one capacitance modulated by the hand making use of the AC voltage; and a computation unit to generate control data from the captured capacitance from at least one of the computation units. It is characterised by the fact that the AC voltage is a square wave.

The square wave, when compared to a sine-shaped AC voltage, has the advantage that it enables an almost instantaneous capturing of the electrode capacitance. Thus, the time during which the apparatus is sensitive for interference such as interfering pulses is less.

Furthermore, the time saved by using a square wave offers the possibility of discarding individual measurements with strongly deviating results which guarantees higher operation security in electrically unfavourable environments.

In an advantageous embodiment of the AC voltage feed the latter is configured in such a manner that it feeds the AC voltage to at least one of the number of electrodes.

In a first embodiment of the inventive apparatus, the at least one capture unit is formed and located in such a manner that the at least capacitance modulated by the hand and to be captured is the stray capacitance of the electrodes. In this case the capture unit can favourably comprise an operation amplifier with a non-inverting input terminal, being connected as charge amplifier, whereby the AC voltage is fed to the non-inverting input terminal of the operation amplifier. This means the AC voltage is connected to the non-inverting input terminal of the operation amplifier.

In a second embodiment of the inventive apparatus, the at least one capture unit is designed in such a manner that at least one capacitance modulated by the hand and to be captured is the coupling capacitance between at least one of the electrodes and the hand.

While in the first embodiment of the inventive apparatus one amplifier and one analog digital converter together with at least one multiplexer or several amplifiers and several analog digital converters are required, the second embodiment only requires one amplifier and one analog digital converter. A shield membrane for shielding the electrodes is not required either in the second design.

However, measures have to be taken in the second embodiment to prevent the current flowing through the capacitances from flowing to the ground potential instead of the capture unit at any point in time. This happens when the hand or any other part of the body has contact with the ground potential. As one measure to be taken, the second embodiment may comprise a decoupling device for decoupling the potentials of the electrode circuit from any grounded circuits. This type of measure is not necessarily required in the first embodiment.

The object of this invention is also realised by an apparatus for controlling a cursor by modulating the capacitances by a hand which comprises: an electrode circuit comprising a number of electrodes, whereby the electrodes are located and shaped such that they can form capacitances (Cᵢ, Cⱼ) which can be modulated by a hand; at least one AC feed for feeding AC voltage; at least one capture unit for capturing at least one capacitance modulated by the hand making use of the AC voltage; and a computation unit to generate control data from the capacitance captured by the capture unit; whereby the apparatus is coupled signalwise to a grounded circuit. It is characterized in that a decoupling unit is provided for voltage-decoupling the circuit comprising the electrodes from the grounded circuit.

By voltage-decoupling it is achieved that the current flowing through the capacitances will still flow to the measurement (capture) unit when the hand contacts the ground potential.

Decoupling the potential can be done, for example, by feeding the measurement (capture) circuit with its own transformer or an ungrounded DC/DC converter. The signal coupling of an ungrounded (i.e. voltage-decoupled) measurement (capture) circuit to the grounded circuits of the computer is performed with an optical coupler.

More features, characteristics and advantages of this claim are described in the following with reference to the enclosed drawings on the basis of examples of the design.

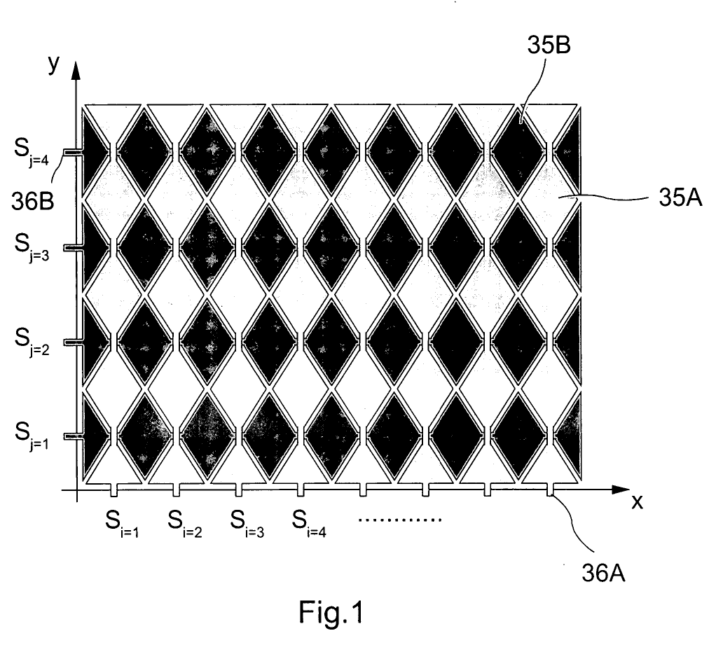

FIG. 1 depicts a possible arrangement of electrodes for a capacitive apparatus for entering positional data.

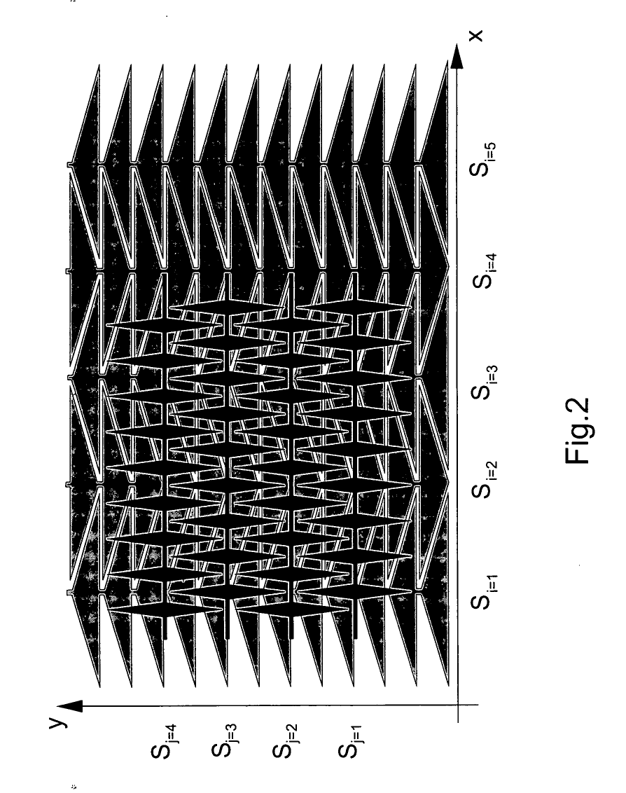

FIG. 2 depicts an alternative arrangement of electrodes of a capacitive apparatus for entering positional data.

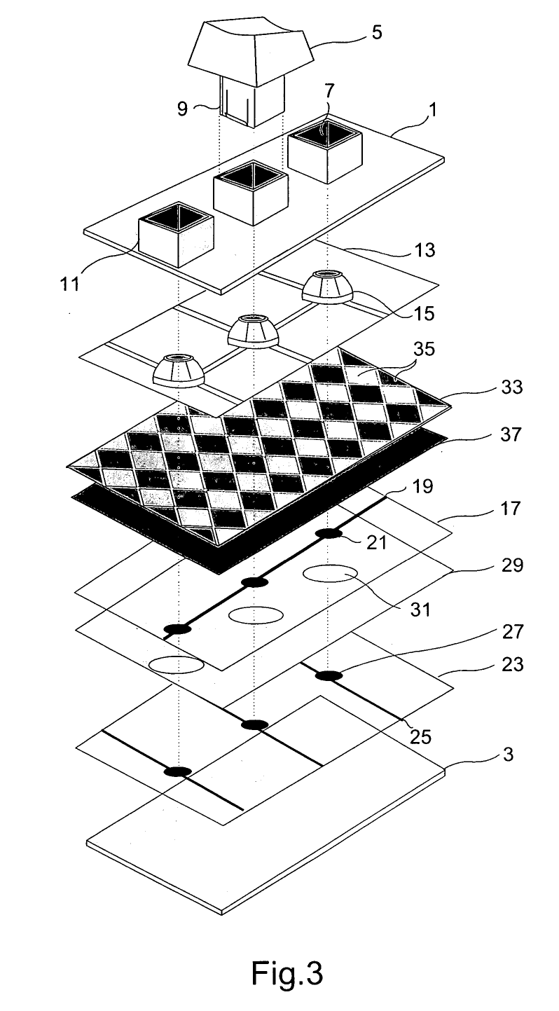

FIG. 3 depicts, in an exploded view, the embodiment of an inventive keyboard in the case of a long-travel keyboard.

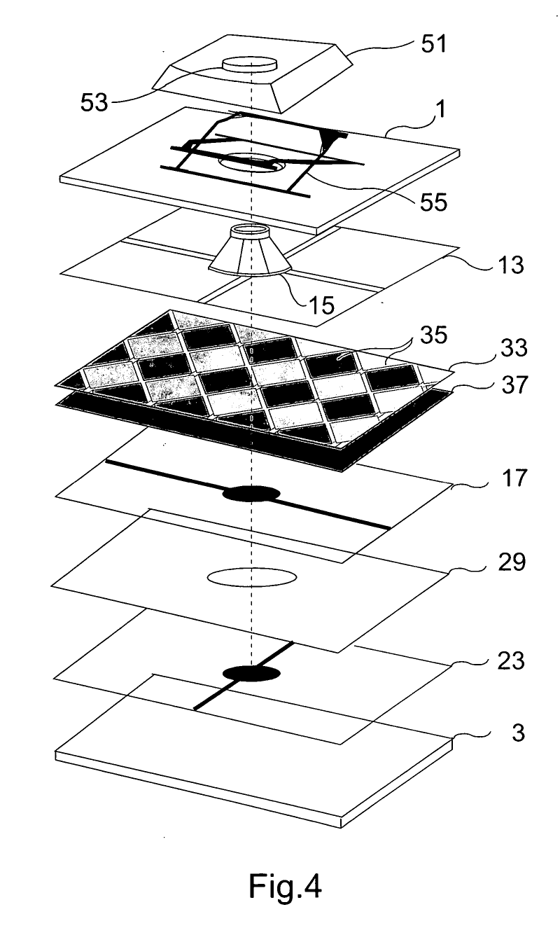

FIG. 4 depicts, in an exploded view, the embodiment of an inventive keyboard in the case of a short-travel keyboard.

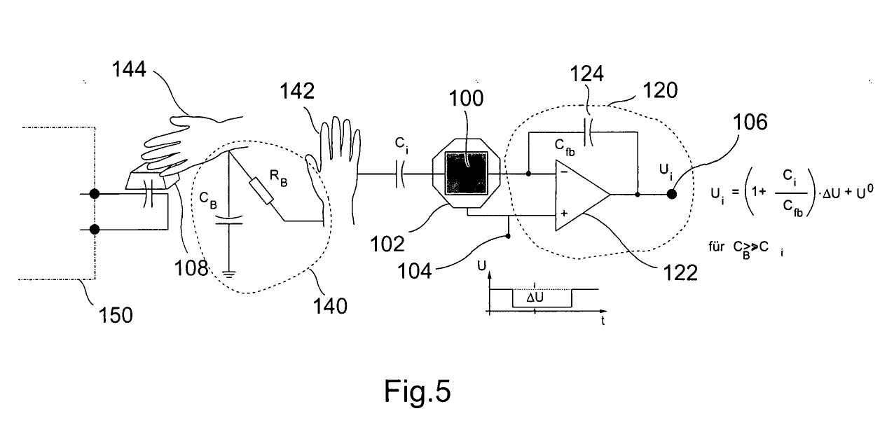

FIG. 5 depicts a first embodiment of a readout electronics for reading out the capacitances of an electrode arrangement.

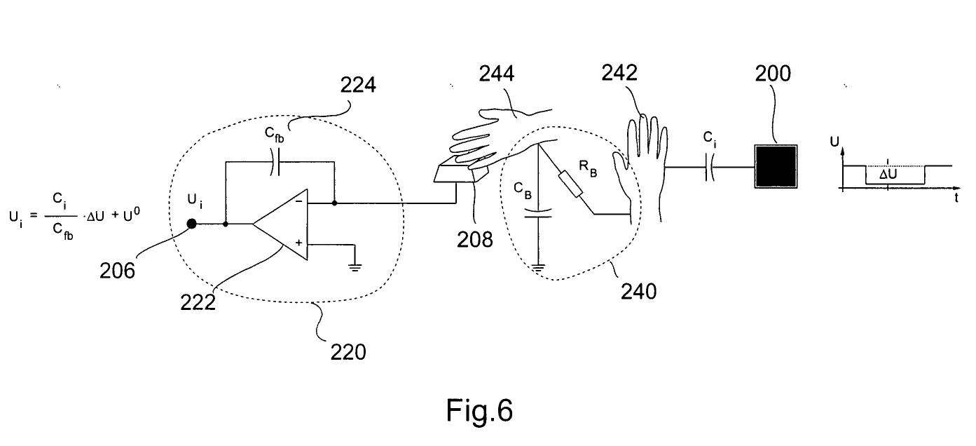

FIG. 6 depicts a second embodiment of a readout electronics for reading out the capacitances of an electrode configuration.

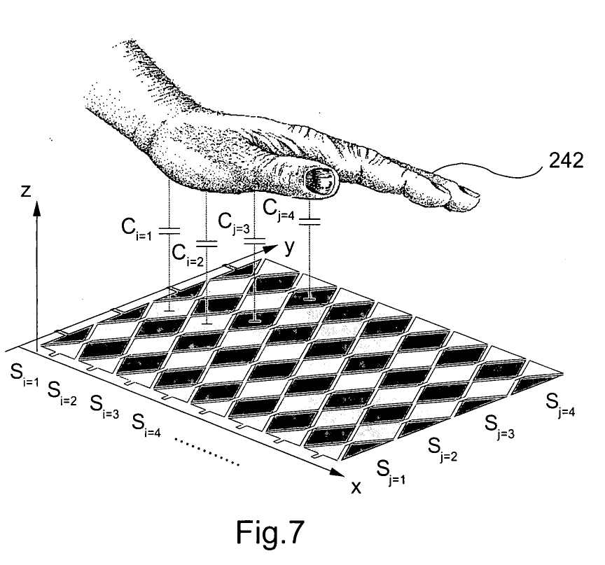

FIG. 7 depicts stray capacitances between a hand and electrodes of an electrode arrangement.

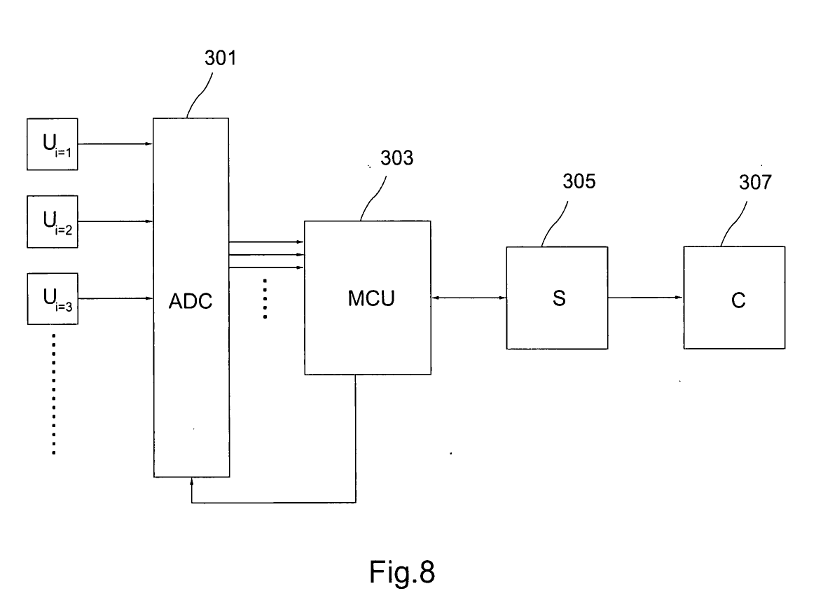

FIG. 8 depicts a processing circuit for processing voltage values representing read-out capacitances.

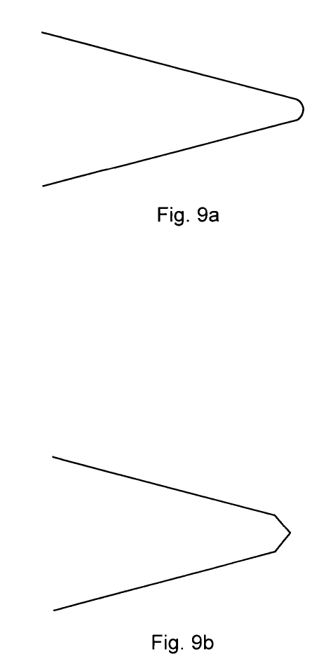

FIGS. 9a and 9b depict alternative embodiments of electrodes in an electrode arrangement.

2.3 Mechanical Arrangement

FIGS. 3 and 4 illustrate two embodiments of the inventive keyboard, i.e. two realisations of a combination of computer keyboard and mouse control apparatus.

FIG. 3 shows, in an explosive view, the design in the case of a long-travel keyboard in the manner it is typically used together with desktop PCs.

The keyboard comprises a keyboard housing with an upper side 1 and lower side 3. The keys 5 are arranged on the upper side of the keyboard housing 1. On their lower sides in the direction of the keyboard housing, the keys 5 feature the protruding tappet 9 extending through openings 7 of the upper side of the housing 1. The holes 7 are surrounded by protruding walls 11 in the direction of the keys 5 to lead the tappets 9.

Below the upper side of the housing 1 there is a rubber mat 13 with protuberances 15 in the direction of the keys 5 mounted in the housing in such a manner that there is a protuberance 15 beneath each key 5.

Underneath the rubber mat 13 there is an upper keyboard membrane 17 on the lower side of which upper circuit traces 19 and upper contact electrodes 21 are mounted, and a lower keyboard membrane 23 on the upper side of which lower circuit traces 25 and the upper contact electrode 27 are mounted. The circuit traces 19,25 of the upper and lower keyboard membrane 17,23 mainly run vertically toward each other and interconnect contact electrodes 21, 27 arranged on a line. Between the upper keyboard membrane 17 and the lower keyboard membrane 23 there is an spacer membrane 29, in which there are holes 31 in the locations where upper and lower contacts 21, 27 are opposite each other, such, that when pressure is exerted on key 5 the upper keyboard membrane 17 is pressed into the respective hole 31 and the two contact electrodes 21,27 make contact with each other. The keyboard membranes 17,23, together with the offset membrane, make up for a number of membrane switches assigned to the respective keys 5. As well as the membranes forming the membrane switches there is an electrode membrane 33 above the upper keyboard membrane 17 with a number of rhombus-shaped electrodes 35 which form the electrodes of the capacitive mouse control apparatus.

There is also a shield membrane 37 located between the electrode membrane 33 and the upper keyboard membrane 17 in order to suppress crosstalk of signals on the contact electrodes 21, 27 and the circuit traces 19, 25 to the electrodes 35 on the electrode membrane 33.

The configuration illustrated, with the exception of the additional electrode and shield membranes 33, 37, is equivalent to a conventional long-travel keyboard. The switches are designed as so-called membrane switches. They are activated when a keystroke of a key 5 presses the respective tappet 9 through the hole 7 in the upper side of the housing 1 on the protuberances 15 of the rubber mat 13, the electrode membrane 33 and the shield membrane 37 and finally on the membrane switch comprising the upper keyboard membrane 17, offset membrane 31 and keyboard membrane 23. This pressure causes the upper keyboard membrane 17 to be pressed into the hole 31 of the offset membrane 29 so that upper and lower contact electrodes 21,27 make conductive contact which is detected by a scanning electronics. If there is a sufficient number of thin and flexible additional membranes, the mechanical pressure will be transmitted downward without hindering the principle. It becomes clear that the electrode and shield membranes 33,37 required for the touchpad functionality are an independent, modular supplement for a conventional long-travel keyboard.

The embodiment in the case of a short-travel keyboard (FIG. 4), for example in the way they are used for portable PCs (Laptops) or cordless keyboards, is very similar. In contrast to a long-travel keyboard, the moveable key 50 comprises only a cap 51 and possibly a short tappet 53, which is maintained by scissors-like mechanics 55. The remaining components are equivalent to those in the long-travel keyboard and therefore no further explanation is required at this point.

Modifications of the aforementioned arrangements are, of course, possible and are (will be) also protected by this patent. For example, two or more membranes, each with one or more conductive layers could be used instead of one electrode membrane with two conductive layers. The shield membrane could be foregone completely if a suitable synchronisation ensures that no interfering pulses will be sent from the circuit paths of the keyboard membranes (or from other sources of interference) at the time the capacitances are measured.

Further, the shield membrane could be applied to the lower side of the electrode membrane or the upper side of the keyboard membrane as an additional conductive layer.

Moreover, the insulation between each layer of electrodes and/or shield layer could be applied using print technology so that all conductive and insulating layers on the upper side of the topmost keyboard membrane could be printed. The advantages of the mechanical arrangement when compared to earlier-methods are as follows:
the electrode arrangement can be designed as desired and no consideration has to be given to the key arrangement or the position of the holes in the keyboard housing.
The electrodes are safely placed within the body of the housing.
Graphite or silver-printed membranes are state-of-the-art and cheap.
The electrode membranes are a casual, modular supplement to the types of membrane keyboards used so far. The well-proven principle of the membrane switch can continue to be used.
   2.4 Electrode Arrangement.

The object of the mouse control apparatus is to calculate a pointer position on the monitor from the position of the user's hand.

For this purpose, the electrodes on the electrode membrane are structured in such a manner that the position of the hand can be determined by determining the capacitance between the electrodes and the hand or between the electrodes and the environment (‘ground’).

FIG. 1 gives an illustration of a possible electrode arrangement as it is used in a popular version of capacitive touchpads [2]. The electrodes 35 consist of a row of rhombuses, whereby the brightly illustrated electrodes, in particular their rhombuses 35A, are electrically connected by the vertical lines 36A in the figure, the darkly illustrated electrodes and in particular their rhombuses 35B, to the horizontal lines 36B in the figure (in fact, the interconnected rhombuses represent one single electrode). They can, for example, be printed on polyester membranes using carbon or silver ink in a screen process. The capacitance measurement and the resulting definition of a pointer coordinate is explained in more detail in the paragraph describing the treatment of the two electronics embodiments.

In order to prevent the injection of interfering signals, which primarily transmit from the keyboard membrane 17,23 or from the computer and bus line in the case of a portable computer, a conductive layer (shield) is placed between the sensor level and the sources of interference. This is not necessarily required for electronics embodiment 2.

A disadvantage of the electrode arrangement described above is that a relatively high number of electrodes 35 is required to achieve a fine resolution. Thus the distance between two electrodes 35 in space (and hence the lateral circumference of an electrode) is ideally less than the circumference of a fingertip. Otherwise, the (bright) electrodes 35A could have a very high capacitance to the finger, but the (dark) electrodes 35B from the other direction in space only a very low one, which would lead to high inaccuracy of the position determination in this dimension. While a small distance between the electrodes presents no problem in the small area of a touchpad, the number of electrodes 35 multiplies on the larger area of a keyboard and the electronic channels connected to them. Moreover, the signals of the individual electrodes 35 lessen to the same extent their area decreases.

In the improved layout in FIG. 2, even a fingertip is always above the electrodes of both directions in space at any given time using the same electrode distance and same area of the electrodes. Pointed rhombuses and triangles are used as the basic design. You can see that the lower grey electrode design continues unchanged below the upper black electrode design; whereby the lower electrodes are partially shielded by the upper ones. The advantages of the electrode arrangement described above when compared to the patents quoted in the introduction and the common arrangement used in touchpads are as follows:
The electrode arrangement is only used capacitively; the conductivity of the printed circuit paths and electrodes is therefore uncritical.
A ratiometric interpolation is only carried out between two adjacent electrodes, and not across the entire width or length of the touch-sensitive area. Therefore, local inhomogeneities can only have much smaller effect.
Small objects too such as fingertips can be localised precisely in x and y direction with relatively few electrodes.
When a finger moves from one electrode to the adjacent one, the rhombus shape or triangle shape enable soft transition of the capacitance between the respective electrodes, which is important for a uniform, steady flow of the mouse pointer. The more pointed the angle of the rhombuses or triangles, the more uniform is the flow.
   2.5 First Electronic Apparatus

In the first embodiment for an electronic apparatus for determining the presence of a hand above an electrode area, hereafter referred to as “Electronic Apparatus 1”, the presence of the hand is determined by the fact that the stray capacitance of the electrodes Sᵢ and Sⱼ increases because the hand shows a larger dielectricity constant ε than air.

The first embodiment for an electronic apparatus is the preferred readout electronics. FIG. 5 illustrates this apparatus. It shows a sensor 100, a shield 102, an AC voltage input 104, an output 106, which generates an output voltage Uᵢ for further processing by an analog digital converter not illustrated, as well as a charge amplifier 120. A schematic illustration of an electrode as the sensor area is shown in FIG. 5, which, for example, can be an electrode Sᵢ or Sⱼ in FIG. 1. The charge amplifier 120, which is a special form of a transimpedance amplifier, comprises an operation amplifier 122, to which an AC voltage signal coming from the AC voltage input 104 connects at its non-inverting input terminal “+”. The inverting input terminal “−” of the operation amplifier is connected to the sensor 100, while the output of the operation amplifier 122 is connected to the output of the first electronic apparatus. Moreover, the output of the operation amplifier 122 is fed back to the inverting input via a capacitor C_{fb} 124.

FIG. 5 also illustrates an equivalent circuit diagram 140 for the body of a keyboard user, which comprises the first hand 142, whose presence has to be determined, the ohmic resistance R_{B} and the capacitance C_{B} of his or her body, as well as the second hand 144, which is located near a capacitance proximity switch 150 connected to a mouse button 108 (this will be described later in 2.7).

An AC voltage signal, e.g. a square wave with voltage jump ΔU is given on the non-inverting input of the operation amplifier 122. According to Eq. (1), the output power Uₛ from the charge amplifier 120 after the voltage jump depends on the stray capacitance Cᵢ of the electrode Sᵢ against the environment. In the event that Cᵢ is significantly smaller than the body capacitance C_{B}, Cᵢ is the capacitance between electrode Sᵢ, i.e. the sensor area 100, and hand 142. U⁰ is the voltage on the amplifier output prior to the voltage jump.

$${U}_{i} = ( 1 + \frac{{C}_{i}}{{C}_{fb}} ) \cdot Δ U + {U}^{0} = Δ U + \frac{{Q}_{i}}{{C}_{fb}} + {U}^{0} \qquad ( 1 )$$

By sampling the amplifier output just before and after the signal edge and subtracting the two voltage values and ΔU, one receives a measurement for the electrode capacitance Cᵢ on the input of the amplifier. If the output voltage Uᵢ threatens to go beyond the supply voltage as a result of the term ΔU, or if it is above the input voltage range of the following analog digital converter, it can be reduced by a compensation capacitance, one side of which is connected to the amplifier input wire and the other side of which receives an amplified copy of the voltage jump signal ΔU. Eq. (1) applies both to electrodes Sᵢ running in the x direction and also the electrodes Sⱼ running in y direction. For reasons of simplicity, only the equations for index i are given.

The advantage of using a square wave is that one can perform almost instantaneous measurements of the electrode capacitances. The capacitance is completely determined by measuring just before and just after the voltage jump; interference is limited to the time window between the two measurements, which is only restricted by the amplifier slew time. The sensitive time of the system is thus significantly shorter than when using a sine voltage and follow-on synchronous detection as in [9,10]. The pointer coordinates X, Y are calculated according to Eqs. (2) and (3), whereby the connected electrodes Sᵢ, Sⱼ exhibit the capacitances Cᵢ, Cⱼ against ground.

$$\begin{matrix}X = \frac{{\sum }_{j = 1}^{m} {C}_{j} {x}_{j}}{{\sum }_{j = 1}^{m} {C}_{j}} & ( 2 ) \\ Y = \frac{{\sum }_{i = 1}^{n} {C}_{i} y}{{\sum }_{i = 1}^{n} {C}_{i}} & ( 3 )\end{matrix}$$

The hand can be moved in the x, y and z direction within the boundaries given by the sensitivity of the charge measurement. In Electronic Apparatus 1, shield 102 is kept on the same potential as the electrodes, in particular it thus carries out the voltage jumps too so that the capacitance between the electrodes and shield 102 does not have to be recharged. Not every electrode has to be measured from its own amplifier. In order to save components, multiplexers (changeover switches) can be placed both in front of and behind the amplifiers.

2.6 Second Electronic Apparatus

FIG. 6 shows a second embodiment for the electronic apparatus, hereafter referred to as “Electronic Apparatus 2”, which is also suitable for determining the position of the hand. For this purpose, the coupling capacitance Cᵢ between electrode Sᵢ and the hand is measured primarily, and not the stray capacitance of the electrodes Sᵢ as in electronic apparatus 1.

The second electronic apparatus features an electrode 200, a mouse button 208, an output 206, which generates an output voltage Uᵢ for further processing by an analog digital converter not illustrated, and a charge amplifier 220. In FIG. 6 an electrode is illustrated schematically as electrode 200 which for example can be an electrode Sᵢ or Sⱼ from FIG. 1.

The charge amplifier 220 comprises an operation amplifier 222, whose non-inverting input terminal “+” is connected to ground. The inverting input terminal “−” of the operation amplifier is connected to the mouse button 208, while the output of the operation amplifier 222 is connected to the output 206 of electronic apparatus 2. Moreover, the output 206 of the operation amplifier 222 is fed back to the inverting input via a capacitor Ca, 224.

An equivalent circuit diagram 240 for the body of a keyboard user is also illustrated, this comprises the first hand 242, whose presence has to be determined, the ohmic resistance R_{B} and the capacitance C_{B} of his or her body, as well as the second hand 244, which is located near the mouse button 208.

The right hand is positioned on the keyboard above the electrode plane, while the left hand 244 in Electronic Apparatus 2 contacts a special electrode 208, which is coupled to the input of the charge amplifier system 220 and which can be embodied as a mouse button (FIG. 6). The individual electrodes in the electrode plane are connected successively to an AC voltage. This AC voltage can, for example, be a square wave. A possible means of realisation could be a shift register in which a digit pattern . . . 0-0-0-1-1-1 . . . is fed into its serial input, and whose parallel output is connected to the electrodes. Thus a new electrode will successively receive a voltage jump ΔU with each timing pulse.

If there is now a certain stray capacitance between the electrodes 200 and the hand 242, the voltage jump causes a charge to be induced to the hand 242, which is ‘sucked in’ by the connected charge amplifier and converted into voltage. FIG. 7 shows five such stray capacitances between different electrodes; in general there will always be a finite though small stray capacitances between each of the electrodes Sᵢ, Sⱼ and the hand.

According to Eq. (4), the increased voltages Uᵢ are proportional to the stray capacitances Cᵢ between the electrodes Sᵢ, Sⱼ and the hand 242, and the voltage jump ΔU. U⁰ characterises the offset voltage of the charge amplifier 220.

$${U}_{i} = \frac{{C}_{i}}{{C}_{fb}} Δ U + {U}^{0} = \frac{{Q}_{i}}{{C}_{fb}} + {U}^{0} \qquad ( 4 )$$

As in the case of electronic apparatus 1, a measurement for the capacitances Cᵢ can be obtained by sampling the amplifier output before and after a voltage jump and calculating the difference.

The voltages transmitted and the pertinent currents within the human body are the same dimension as in electronic apparatus 1 (and in all capacitive touchpads or proximity switches); they are far below any detectable and dangerous threshold.

In order to be able to process the rapid sequence of power pulses a quick reset of the amplifier is required after each voltage jump. For this purpose, methods [11 ] known from the field of high-energy physics can be used.

With respect to the electrode geometries, the samples shown in FIGS. 1 and 2 can likewise be used. In addition, the method of computing the mouse coordinates described in connection with the electronic apparatus 1, and which is also described in formulae (2), (3) can continue to be used.

In the electronic apparatus 2, shielding is not stringently required because the electrodes themselves provide shielding in an upward direction (toward the hand) against any interfering pulses from the keyboard membrane or any other sources of interference below the keyboard. However, should interferences still penetrate through the electrode gaps, this can be prevented by a continuous shield on ground potential.

A significant advantage of this method is that—without losses in the quality of the signals—only one amplifier and one analog digital converter is required within the chain of signal samplings.

A further advantage of this method is that a larger voltage pulse ΔU can be used for the same supply voltage because it does not occur as a constant additive term at the amplifier output as in Eq. (1). This increases the signal-to noise ratio.

A further advantage is that the shield membrane is not required.

The greatest disadvantage of this method appears to be the breakdown of the charging signal when the body touches a grounded object. In principle, this problem can be solved by a potential, in particular galvanic, decoupling of the electrode circuit from the grounded circuits of the computer; however, this type of decoupling requires a lot of effort, it consumes more current, it is critical from the point of view of noise, and the charge amplifier has to recharge the inevitable parasitic capacitances between the electrode circuit and ground during each voltage jump.

2.7 Mouse Buttons and Switchover from Keyboard to Mouse Mode

The mouse buttons 108 (in FIG. 5), 208 (in FIG. 6) are arranged next to the keys on the keyboard on the same housing. They are operated by the hand 144,244 not operating the mouse pointer. For a right-handed person, the operating hand is 142,242 and for a left-handed person, the hand operating the mouse buttons is 144,244.

In electronic apparatus 1 the mouse mode is activated in the preferred embodiment by a commercial capacitive proximity switch 150 whose measuring electrode is located around the mouse buttons 108, for example below the PVC housing. Thus switchover to the mouse mode is always performed when the left hand 144 is in proximity of the mouse buttons 108.

If the signal is weak, an electrode can also be mounted on or next to the mouse buttons 108, which will be grounded (zero potential). When the hand touches the electrode, the condition Cᵢ<<Cs for formula (1) is not required any more. Please also see the following description for electronic apparatus 2. However, care has to be taken to ensure that the conductive and grounded area does not shield the stray field of the measuring electrode of the proximity switch.

In another embodiment, the mouse button is conductive, in that it is covered with a conductive material or in that it is made of (not too thick) anodised aluminium. The mouse mode is activated when the left hand touches the mouse button. The conductive cover of the mouse button or the mouse button made of anodised aluminium is grounded when a hand position measurement is made, and connected to the commercial capacitive proximity switch, if a touch of the button is to be detected, for example when checking for a switch over to the mouse mode.

In the electronic apparatus 2, there has to be a conductive contact between the body and an electrode which is connected to the input of a charge amplifier. The best thing to do is to make the mouse buttons as conductive electrodes themselves, e.g. by making them out of (not too thick) anodised aluminium. The mouse mode is activated when the left hand 244 touches the mouse button 208 (see FIG. 6) because then (and only then) can the signals of the electrode 200 reach the input of the charge amplifier 220 from the right hand 242 via the left hand 244 via body conduction. Therefore, only a threshold comparison by the program of the following micro-controller is required to activate the mouse mode.

Of course, both the electronic apparatus 1 and the electronic apparatus 2 have the capability of toggling between the keyboard and mouse mode with a dedicated key or with a dedicated button, whether it is mounted as an integral part of the keyboard panel or next to it. In the electronic apparatus 2, guarantee has to be given that there is always a conductive connection between the hand and the charge amplifier.

2. 8 Overall Electronic System

FIG. 8 depicts the further processing of the voltage values measured up to the transfer of the data to the computer, using the electronic apparatus 1 as an example.

Analog digital converters (ADC) 301 convert the voltages Uᵢ coming from the charge amplifiers 120 to digital values, which are then forwarded to a micro-controller (MCU) 303. The micro-controller 303 computes the mouse coordinates X und Y according to the Eqs. (2) und (3), which it then transmits to the computer (C) 307 via a serial interface 305 (e.g. PS/2, RS232, USB, as shown in FIG. 8 as S), where the data is then used for controlling the mouse pointer. All components can be integrated onto a chip; this results in a further possibility of the computation being performed by hard-wired logic instead of by a programmable micro-controller.

### 3. SPECIAL EMBODIMENTS

This invention can, in particular, be realised by the keyboards or apparatuses described in the following:

3.1 Mechanical Arrangement

A keyboard with a capacitive apparatus for inserting positioning data for a mouse pointer which comprises at least one electrode characterised in that the at least one electrode is arranged beneath the keys.

A keyboard with a capacitive apparatus for entering positioning data for a mouse pointer which comprises at least one electrode characterised in that the at least one electrode is arranged beneath the keys within the keyboard housing. Note: Both [8] and [10] describe the electrodes being located on the upper side of the housing/carrier.

3.2 Electrode Geometry

A keyboard with a capacitive apparatus for entering positioning data for a mouse pointer which comprises at least five electrodes characterised in that the at least five electrodes have pointed angles of less than 45 degrees.

For the particular embodiments described here and for the other peak electrode geometries described in the application, there is always a rounding of the angle from a microscopic standpoint (FIG. 9a); this is not to be regarded as justification for a circumvention. You can also bypass pointed corners by many flat angles within a small space (FIG. 9b); from the point of view of this invention, both versions are to be regarded as pointed angles.

3.3 Electronic Apparatus

An apparatus for steering the cursor with the hand using a number of electrodes which can form capacitances with the hand, one or more means for feeding AC voltage to the capacitances, one or more means for determining the capacitances on the basis of the AC voltage and means of generating control data from the capacitance values, characterised in that the AC voltage is a square wave.

An apparatus for steering the cursor with the hand using a number of electrodes which can form capacitances with the hand, one or more means of feeding AC voltage to the capacitances, one or more means of determining the capacitances on the basis of the AC voltage and means of generating control data from the capacitance values, characterised in that the AC voltage is fed via the electrodes and that the hand serves as part of the determination means.

An apparatus for steering the cursor with the hand using a number of electrodes which can form capacitances with the hand, one or more means of feeding AC voltage to the capacitances, one or more means of determining the capacitances on the basis of the AC voltage and means of generating control data from the capacitance values, characterised in that the current flowing through the capacitances does not flow through the ground potential at any given time if the hand itself is not connected to ground potential.

### LITERATURE

[1] U.S. Pat. No. 3,835,464, R. E. Rider,“Position indicator for a display system”, 10 Sep. 1974
[2] U.S. Pat. No. 6,028,271, Gillespie et al.,“Object position detector with edge motion feature and gesture recognition”, 22 Feb. 2000
[3] U.S. Pat. No. 5,305,017, G. E. Gerpheide,“Methods and apparatus for data input”, 19 Apr. 1994
[4] WO9618179, Gerpheide et al.,“Capacitance based proximity sensor with interference rejection apparatus and methods”, 13 Jun. 1996
[5] U.S. Pat. No. 5,521,596, E. J. Selker,“Analog input device located in the primary typing area of a keyboard, 28 May 1996
[6] U.S. Pat. No. 5,821,922, C. Sellers,“Computer having video controlled cursor system”, 13 Oct. 1998
[7] U.S. Pat. No. 5,675,361, D. Santilli,“Computer keyboard pointing device”, 07 Oct. 1997
[8] WO98/05025, H. Philipp,“Capacitive Position Sensor”, 05 Feb. 1998
[9] WO99/52027, H. R. Sterling, “Positioning a cursor on the display screen of a computer”, 14 Oct. 1999
[10] U.S. Pat. No. 6,204,839 B1, S. A. Mato, Jr., “Capacitive sensing keyboard and pointing device”, 20 Mar. 2001
[11] W. Fallot-Burghardt,“A CMOS Mixed-Signal Readout Chip for the Microstrip Detectors of Hera-B”, Dissertation, 24 Jun. 1998
[12] WO00/73984 A1, Kent et al.,“Projective Capacitive Touchscreen”, 07 Dec. 2000

1. Keyboard, in particular computer keyboard, including a keyboard housing (1,3) and a capacitive apparatus, comprising at least one electrode (35) shaped in such a manner that positional data can be entered by hand movement over the keyboard, characterized in that the at least one electrode (35) is located inside the keyboard housing (1,3).

2. The keyboard of claim 1, including a number of keys (5,50), characterized in that the at least one electrode (35) is located at least partially beneath at least one key (5,50).

3. The keyboard of claim 2, characterized in that the keys (5,50) comprise a tappet (9,53), and that at least one electrode is located at least partially beneath the tappet of at least one key (5,50).

4. The keyboard of any of the preceding claims, characterized in that the at least one electrode (35) is applied to an electrode membrane (33).

5. The keyboard of claim 4, characterized in that the electrode membrane (33) is a polyester membrane.

6. The keyboard of claim 4 or 5, characterized in that the at least one electrode (35) is printed on the electrode membrane (33).

7. The keyboard of any of claims 4-6, characterized in that the keyboard comprises membrane switches (17,23,29), and that the electrode membrane (33) is located above the membrane switches (17,23,29).

8. The keyboard of claim 7, characterized in that a shield (37) is located between electrode membrane (33) and membrane switches (17,23,29).

9. The keyboard of claim 8, characterized in that the shield is realised as shield membrane (37).

10. The keyboard of claim 8, characterized in that the shield (37) is applied to the side of the electrode membrane (33) opposite of the side to which the at least one electrode (35) has been applied to.

11. The keyboard of claim 8, characterized in that the membrane switches (17,23,29) comprise an upper keyboard membrane (17), and the shield (37) is applied to the upper side of the upper keyboard membrane (17).

12. The keyboard of any of claims 1-6, characterized in that the keyboard comprises membrane switches (17,23,29) including an upper keyboard membrane (17), and the at least one electrode (35) is applied to the upper keyboard membrane.

13. Electrode arrangement, in particular for insertion into a keyboard housing, characterized in that it comprises at least two electrodes (Si,Sj), each of them being confined by a polygon line having at least two corners with angles of less than 45 degrees.

14. The electrode arrangement of claim 13, characterized in that at least two of the at least two electrodes (Sᵢ,Sⱼ) substantially extend into orthogonal directions.

15. The electrode arrangement of claim 14, characterized in that at least one electrode (Sⱼ) is constructed from a concatenation of triangles, and/or at least one electrode (Sᵢ) extending into an orthogonal direction is constructed from a concatenation of rhombuses.

16. The electrode arrangement of any of claims 13-15, characterized in that the electrodes (Sᵢ,Sⱼ) are applied to an electrode membrane (33).

17. The electrode arrangement of claim 16, characterized in that the electrodes (Sᵢ,Sⱼ) are printed on the electrode membrane (33).

18. The electrode arrangement of claim 16 or 17, characterized in that the electrode membrane (33) is at the same time a keyboard membrane of the keyboard switches (17,23,29).

19. The electrode arrangement of claim 18, characterized in that the electrode membrane (33) is at the same time an upper keyboard membrane (17) and the electrodes (Sᵢ,Sⱼ) are applied to the upper side of the upper keyboard membrane (17).

20. Apparatus for steering a cursor by modulating capacitances with a hand, comprising
a number of electrodes (35,Sᵢ,Sⱼ), being located and shaped such that they can form capacitances (Ci,Cj) which can be modulated by a hand (142,242)
at least one AC voltage feed (104) for feeding an AC voltage (ΔU)
at least one capture unit (120,220) for capturing at least one capacitance (Cᵢ,Cⱼ) being modulated by the hand, making use of the fed AC voltage (ΔU)
a computation unit (303) for generating control data for steering a cursor from the at least one capacitance (Ci,Cj) being captured by the capture unit (120,220)
characterized in that
the AC voltage (ΔU) is a square wave.

21. The apparatus of claim 20, characterized in that the AC voltage feed (104) is formed such that the AC voltage is fed to at least one electrode (35) of the number of electrodes (35,Sᵢ,Sⱼ).

22. The apparatus of claim 20 or 21, characterized in that the at least one capture unit (120,220) is shaped and located such that the at least one capacitance to be captured, being modulated by the hand, is the stray capacitance of the electrodes (35,Sᵢ,Sⱼ).

23. The apparatus of claim 22, characterized in that the capture unit comprises an operation amplifier (122) being connected as charge amplifier, having a non-inverting input terminal, and the AC voltage (ΔU) being fed to to the non-inverting input terminal of the operation amplifier (122).

24. The apparatus of claim 20 or 21, characterized in that the at least one capture unit (220) is shaped and located such, that the at least one capacitance (Cᵢ,Cⱼ) being modulated by the hand is the couple capacitance (Cᵢ,Cⱼ) between at least one of electrodes (35,Sᵢ,Sⱼ) and the hand (242).

25. The apparatus of any of claims 20 to 24, characterized in that the apparatus is coupled signalwise to a grounded circuit, and that a decoupling unit is provided for voltage-decoupling the circuit comprising the electrodes (35,Sᵢ,Sⱼ) from the grounded circuit.

26. Apparatus for steering a cursor by modulating capacitances with a hand, comprising
a number of electrodes (35,Sᵢ,Sⱼ), being located and shaped such that they can form capacitances (Cᵢ,Cⱼ) which can be modulated by a hand (142,242)
at least one AC voltage feed (104) for feeding an AC voltage (ΔU)
at least one capture unit (120,220) for capturing at least one capacitance (Cᵢ,Cⱼ) being modulated by the hand, making use of the fed AC voltage (ΔU)
a computation unit (303) for generating control data from the at least one capacitance (Cᵢ,Cⱼ) being captured by the capture unit (120,220), and
at least one grounded circuit, whereby
the apparatus is coupled signalwise to the grounded circuit
characterized in that
a decoupling unit is provided for voltage-decoupling the circuit comprising the electrodes (35,Sᵢ,Sⱼ) from the grounded circuit.

27. The apparatus of any of claims 25 or 26, characterized in that an opto-coupler is provided, by which the signalwise coupling is achieved.

31. A keyboard, in particular computer keyboard, comprising
(a) a plurality of keys,
(b) two or more electrodes made of conducting material,
(c) an electrode arrangement, being formed by said two or more electrodes, being located beneath said plurality of keys,
(d) one or more electrode membranes, being located beneath said plurality of keys,
(e) said one or more electrode membranes carrying said electrode arrangement,
(f) a portion of said one or more membranes, extending over at least two of said two or more electrodes,
(g) said electrode arrangement covering more than approximately a quarter of said portion,
whereby said electrode arrangement forms part of a capacitive measurement apparatus for sensing hand movements over said keys, and whereby said hand movements are converted by a calculation means to movements of a mouse pointer.

32. The keyboard of claim 31, further including membrane switches, wherein at least one of said one or more electrode membranes is located above said membrane switches.

33. The keyboard of claim 32, further including an electric shield, said electric shield being located between said membrane switches and said at least one of said one or more electrode membranes.

34. The keyboard of claim 33, wherein said electric shield is realised as shield membrane.

35. The keyboard of claim 33, wherein said at least one of said electrode membranes carrys said electric shield on a side not carrying any electrodes of said electrode arrangement.

36. The keyboard of claim 33, wherein said membrane switches comprise an upper keyboard membrane with an upper side, said upper side carrying said electric shield.

37. The keyboard of claim 32, wherein said membrane switches comprise an upper keyboard membrane, and wherein said upper keyboard membrane carries said electrode arrangement.

38. The keybord of claim 31, wherein said electrode arrangement covers more than approximately half of said portion.

39. The keybord of claim 38, wherein said electrode arrangement covers more than approximately three quarters of said portion.

40. The keybord of claim 31, wherein said electrode arrangement is printed on at least one of said one or more electrode membranes.

41. The keyboard of claim 31, wherein at least one of said one ore more electrode membranes is made of polyester.

42. The keyboard of claim 31, wherein said keys have a tappet at their underside, one of said electrodes being located at least partially beneath the tappet of at least one of said keys.

43. Apparatus for steering a cursor by modulating capacitances with a hand, comprising
(a) a predetermined number of electrodes, being located and shaped such that they can form capacitances with a hand, at least one of said capacitances being modulated by said hand,
(b) at least one AC voltage feed for feeding an AC voltage to said capacitances,
(c) at least one capture unit for measuring said capacitances by making use of said AC voltage, said capture unit being connected to said capacitances,
(d) a computation unit for generating control data for steering a cursor, being connected to said at least one capture unit,
characterized in that
(e) said AC voltage has at least one fast voltage transition.
whereby the capacitance modulation can be determined almost instantaneously, limiting the time susceptible to noise.

44. The apparatus of claim 43, wherein said AC voltage feed feeds the AC voltage to at least one of the predetermined number of electrodes.

45. The apparatus of claim 43, wherein said at least one capture unit is connected to said predetermined number of electrodes.

46. The apparatus of claim 43, wherein said at least one capture unit is connected to said hand.

47. The apparatus of claim 43, wherein said capture unit comprises an operation amplifier being connected as charge amplifier.

48. The apparatus of claim 47, wherein said operation amplifier has a non-inverting input terminal, and said AC voltage is fed to said non-inverting input terminal of the operation amplifier.

49. The apparatus of claim 43, being coupled signalwise to a grounded circuit, further including a decoupling unit for voltage-decoupling the apparatus of claim 43 from said grounded circuit.

50. The apparatus of claim 49, wherein said decoupling unit is an opto-coupler.

51. The apparatus of claim 43, wherein said AC voltage is a square wave.
